(19) United States
(12) Patent Application Publication
(10) Pub. No.: US 2014/0200986 A1
(43) Pub. Date: Jul. 17, 2014

(54) METHOD AND APPARATUS FOR RECOMMENDING A DIRECT MAIL MARKETING CAMPAIGN FOR AN EVENT

(71) Applicant: XEROX CORPORATION, Norwalk, CT (US)

(72) Inventor: MICHAEL E. FARRELL, Rochester, NY (US)

(73) Assignee: Xerox Corporation, Norwalk, CT (US)

(21) Appl. No.: 13/743,101

(22) Filed: Jan. 16, 2013

(51) Int. Cl. G06Q 30/02

(52) U.S. Cl. CPC G06Q 30/0241
USPC 705/14.41; 705/14.5

(57) ABSTRACT

A method, non-transitory computer readable medium, and apparatus for recommending a direct mail marketing campaign for an event are disclosed. For example, the method selects the direct mail marketing campaign for the event from a plurality of marketing campaigns based upon a ranked list of assets, receives one or more parameters associated with the event, selects a direct mail delivery method from a plurality of direct mail delivery methods based upon a comparison of the one or more parameters associated with the event and one or more parameters associated with each one of the plurality of direct mail delivery methods, and recommends the direct mail marketing campaign using the direct mail delivery method that is selected.

The present disclosure relates generally to a solution that helps businesses formulate a marketing strategy and, more particularly, to a method, a computer readable medium, and an apparatus for recommending a direct mail marketing campaign for an event.

### BACKGROUND

Many businesses attempt to use marketing to help promote their business and generate more revenue. Some businesses look for help in determining what marketing strategies to deploy.

Currently, marketing strategies are typically formulated manually by specialized professionals and their services can be extremely expensive. These services may not be affordable for most medium and small sized businesses. As a result, many businesses may be left with an inadequate marketing strategy or no marketing strategy at all.

### SUMMARY

According to aspects illustrated herein, there are provided a method, a non-transitory computer readable medium, and an apparatus for recommending a direct mail marketing campaign for an event. One disclosed feature of the embodiments is a method that selects the direct mail marketing campaign for the event from a plurality of marketing campaigns based upon a ranked list of assets, receives one or more parameters associated with the event, selects a direct mail delivery method from a plurality of direct mail delivery methods based upon a comparison of the one or more parameters associated with the event and one or more parameters associated with each one of the plurality of direct mail delivery methods, and recommends the direct mail marketing campaign using the direct mail delivery method that is selected.

Another disclosed feature of the embodiments is a non-transitory computer-readable medium having stored thereon a plurality of instructions, the plurality of instructions including instructions which, when executed by a processor, cause the processor to perform a method that selects a direct mail marketing campaign for an event from a plurality of marketing campaigns based upon a ranked list of assets, receives one or more parameters associated with the event, selects a direct mail delivery method from a plurality of direct mail delivery methods based upon a comparison of the one or more parameters associated with the event and one or more parameters associated with each one of the plurality of direct mail delivery methods, and recommends the direct mail marketing campaign using the direct mail delivery method that is selected.

Another disclosed feature of the embodiments is an apparatus comprising a processor that is configured to select a direct mail marketing campaign for an event from a plurality of marketing campaigns based upon a ranked list of assets, to receive one or more parameters associated with the event, to select a direct mail delivery method from a plurality of direct mail delivery methods based upon a comparison of the one or more parameters associated with the event and one or more parameters associated with each one of the plurality of direct mail delivery methods, and to recommend the direct mail marketing campaign using the direct mail delivery method that is selected.

### BRIEF DESCRIPTION OF THE DRAWINGS

The teaching of the present disclosure can be readily understood by considering the following detailed description in conjunction with the accompanying drawings, in which:

FIG. 1 illustrates one example of a communication network of the present disclosure;

FIG. 2 illustrates one example of a timeline of the present disclosure;

FIG. 3 illustrates an example flowchart of one embodiment of a method for recommending a direct mail marketing campaign for an event; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and apparatus for recommending a direct mail marketing campaign for an event. As discussed above, many businesses attempt to use marketing to help promote their business and generate more revenue. Some businesses look for help in determining what marketing strategies to deploy.

Currently, marketing strategies are typically formulated manually by specialized professionals and their services can be extremely expensive. These services may not be affordable for most medium and small sized businesses.

In addition, many of these methods require a small business owner to meet with a marketing professional to formulate the marketing strategy. Many small business owners may not have the manpower or time, especially for sole proprietors, to meet in person for an extended period of time with the marketing professional to formulate a marketing strategy. As a result, many businesses may be left with an inadequate marketing strategy or no marketing strategy at all.

In some instances, a direct mail marketing campaign may be determined to be the most effective form of marketing for a small business. However, a small business owner may not be able to properly deploy a direct mail marketing campaign on his or her own. For example, the small business owner may not know what type of direct mail delivery method is the most cost effective based upon the marketing materials and volume of marketing materials that will be sent. In addition, the small business owner may not know the proper dates to send marketing materials to ensure that the marketing materials will reach his or her customers on a timely basis for a scheduled event or key dates for sending “save-the-date” mailings, reminder mailings or invitation mailings.

One embodiment of the present disclosure provides an automated marketing campaign coach that allows small and medium sized businesses to independently decide and select a marketing strategy that fits the business and the business objectives. In one embodiment, the assets of the business may be ranked and a marketing campaign appropriate for the highest ranked asset may be recommended. In one embodiment, if the marketing campaign is selected to be a direct mail marketing campaign based upon the ranked list of assets, the automated marketing campaign coach provides recommendations for a direct mail delivery method based upon information received about an event being promoted by the direct mail marketing campaign.

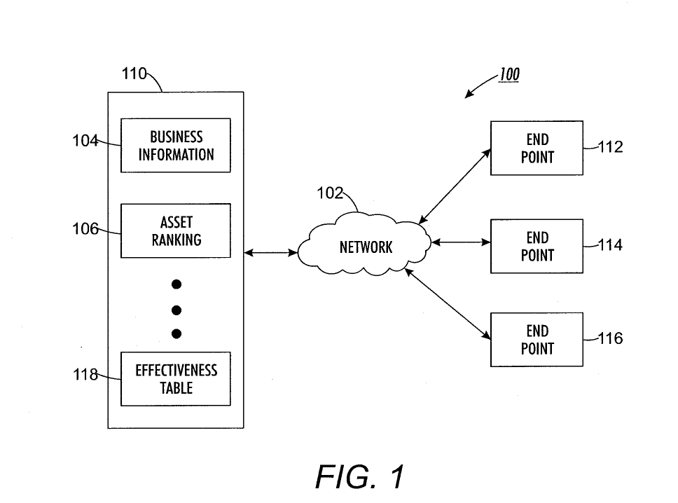

To better understand the present disclosure, FIG. 1 illustrates an example of a communication network 100. In one embodiment, the communication network 100 includes a packet network such as an Internet Protocol (IP) network 102. The IP network 102 may be, for example, the Internet, a service provider network, an access network, a core network, a local area network, and the like.

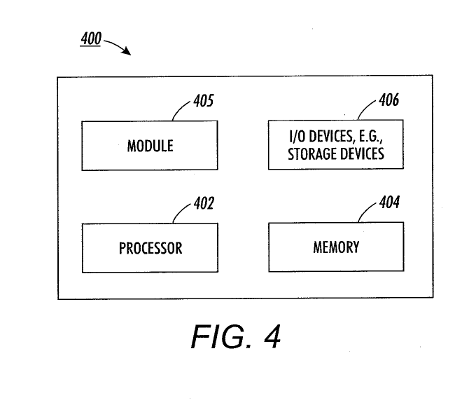

In one embodiment, an automated marketing campaign coach 110 may be in communication with the IP network 102. In one embodiment, the automated marketing campaign coach 110 may include general personal computing capabilities similar to the general computing device described below and illustrated in FIG. 4. In one embodiment, the automated marketing campaign coach 110 may include a storage medium 104 for storing business information, a storage medium 106 for storing a ranked list of assets and a storage medium 118 for storing an effectiveness table.

In one embodiment, the business information may be provided locally by a user. For example, the automated marketing campaign coach 110 may be executed on a general-purpose computer and a user may provide the business information locally. In another embodiment, the automated marketing campaign coach 110 may be centrally located, e.g., on a server in the communication network 100 and accessed remotely by one or more endpoint devices 112, 114 and 116. For example, a user may access the automated marketing campaign coach 110 on a computer in his or her place of business via a web interface.

The one or more endpoint devices 112, 114 and 116 may be any device capable of communicating with the automated marketing campaign coach 110, such as for example, a personal computer, a lap top computer, a tablet device, a smartphone, a cellular phone, a netbook, and the like. Although three endpoint devices 112, 114 and 116 are illustrated in FIG. 1, it should be noted that any number of endpoint devices may be deployed.

It should be noted that the network 100 has been simplified for clarity. For example, the network 100 may include other network elements such as border elements, routers, switches, policy servers, security devices, firewalls, a content distribution network (CDN) and the like. In addition, the network 100 may include additional networks between the endpoint devices and the IP network 102 such as different access networks (e.g., a wired access network, a cable network, a wireless network, a cellular network, a Wireless Fidelity (Wi-Fi) network, and the like) to reach the IP network 102.

In one embodiment, business information that is collected may include, for example, a description of the business (e.g., name, location, type of business, and the like) business assets and/or one or more business objectives for the marketing effort. For example, information about business assets may include customer lists, email lists, prospect lists, logos, web sites, customer purchase history, rewards programs, and the like. For example, information about one or more business objectives for the marketing effort may include events, sales promotion, customer segmentations, new customer acquisition, customer retention, increased revenue, and the like.

Business information may also include upcoming information associated with upcoming events or promotions, e.g., one or more parameters associated with the event. For example, the business may be organizing a promotional event at a store location. The one or more parameters may include a date of the event, a location of the event, a type of marketing materials to be used to promote the event, and the like.

In one embodiment, the campaign coach 110 may rank the assets of the business. In one embodiment, a ranked list of assets for the business may be generated by the campaign coach 110 based upon a quality rating. The campaign coach 110 may then select a marketing campaign tactic based upon the highest ranked asset in the ranked list of assets. The ranked list of assets may be stored in the storage medium 106.

In one embodiment, the assets may be ranked based upon one or more metrics that contribute to the quality rating. For example, the metrics may include a freshness metric, a number of members in the asset, a completeness of the asset, a suitability of print of the asset or an effectiveness of the asset. The freshness metric may measure how recent the asset has been updated or visited. For example, a customer list having a majority of the contact information last updated 5 years ago would have a low quality rating and be considered stale versus a customer list having all of the contact information verified in the past 30 days.

In one embodiment, those assets that have a large number of members (e.g., thousands) would have a higher quality rating than those assets with a small number of members (e.g., hundreds). It should be noted that the terms “large” and “small” are relative terms and the quality score based upon a number of members may be relative to other assets and not necessarily based upon an absolute value.

In one embodiment, those assets that have complete information may have a higher quality rating than those assets that have incomplete information. For example, a customer list may have name information, an address and a telephone number of all of the customers on the list. A prospect list may have name information but only include a telephone number and be missing address information for many of the customers on the list. As a result, the customer list would have a higher quality rating than the prospect list. In another embodiment, those assets that have been processed through address quality services sanctioned by postal systems may have a higher quality rating than those assets that have not. The address quality services may include, for example, Address Element Correction and Coding Accuracy Support System (CASS™)

In one embodiment, those assets that are suitable for print may have a higher quality rating than those assets that are only suitable for web use. For example, a logo having a low resolution may only be suitable for web use and be impractical to be used for print. However, another logo may have a high resolution image that can be used for print and also be used for web use. As a result, the logo suitable for print and web use may have a higher quality rating than the logo suitable only for web use.

In one embodiment, the effectiveness of the asset may be determined based upon a historical measure of a percentage of action taken by a particular group. For example, the campaign coach 110 may have tracked action taken by various groups in previous marketing campaigns using a similar customer list. For example, a customer list of Labrador Retriever owners may show a historical effect on the following groups as follows: about a 10%-15% effect on having Labrador Retriever owners to take action (e.g., show up to the event, make a purchase, respond to the marketing campaign, and the like) in response to the marketing campaign; about a 8%-10% effect on owners of sporting dog breeds to take action; about a 3%-5% effect on owners of all dog breeds to take action; about a 2% effect on all pet owners to take action; and about a 0.5% effect on all people to take action.

In another example, a prospect list of pet owners may show a historical effect on the following groups as follows: about a 0.5% effect on Labrador Retriever owners; about a 0.2% effect on owners of sporting dog breeds to take action; about a 1.0% effect on owners of all dog breeds to take action; about a 5%-10% effect on all pet owners to take action; and about a 0.01% on all people to take action. In one embodiment, the above effectiveness data may be stored in the storage medium 118 for effectiveness tables.

If the business information collected by a particular business is to hold a promotional event for Labrador Retrievers, it can be seen that the customer list of Labrador Retriever owners would have a higher effectiveness at reaching Labrador Retriever owners over a prospect list of pet owners. As a result, the asset of the customer list of Labrador Retriever owners may have a higher quality rating than the asset of the prospect list of pet owners.

The effectiveness of the asset may be a recursive calculation. For example, if the asset is selected to be applied for a marketing campaign, the effectiveness of the asset may be measured for the current marketing campaign. This data may then be used to update the effectiveness percentages for the asset for future analysis, comparisons and/or calculations.

In one embodiment, each asset may be assigned a numerical score or weight value for each metric. The numerical scores or weight values may be added for each metric of an asset to obtain a total score. This may be repeated for each one of the assets. The assets may then be ranked based upon the total score for each asset from a highest score to a lowest score. The ranked list may be stored in the campaign coach 110, e.g., in the storage medium 106.

In one embodiment, once the ranked list of assets is generated the campaign coach 110 may automatically recommend and select a marketing campaign based upon the highest ranked asset. For example, if the highest ranked asset is a customer list, the campaign coach may automatically select a direct mail marketing campaign as the most effective campaign using the customer list asset of the business.

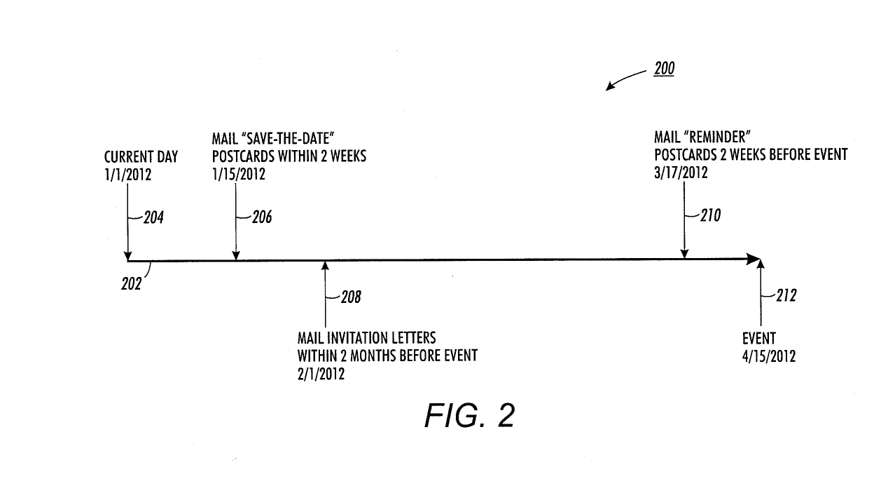

For the direct mail marketing campaign, the campaign coach 110 may automatically compare one or more parameters associated with the event that is being promoted by the business and one or more parameters associated with each one of a plurality of direct mail delivery methods to select and recommend the best direct mail delivery method to the user or business owner. In addition, the campaign coach 110 may provide a timeline of when one or more direct mail marketing materials should be sent using the mail delivery method that is selected based upon the one or more parameters associated with the event as part of the direct mail marketing campaign recommendation. FIG. 2 illustrates one example of a timeline 200 that illustrates mailing dates for various marketing materials that can be recommended by the campaign coach 110.

For example, as noted above, the one or more parameters associated with the event may include a date of the event, a location of the event and a type of marketing material to be used to promote the event. To illustrate, a small business may be holding an event to promote products for Labrador Retriever on Apr. 1, 2012 in Saint Louis, Mo. Using a ranked list of assets, the campaign coach 110 may determine that the highest ranked list is a customer list for Labrador Retriever owners containing 5,000 members. As a result, the campaign coach 110 may determine that a direct mail marketing campaign may be the most effective marketing campaign to advertise for the event.

The campaign coach 110 may also determine that a “save-the-date” postcard, an invitation letter and a reminder postcard should be mailed as marketing materials for the direct mail marketing campaign. The production of the postcards and the invitation letters may have a predetermined lead time.

In one embodiment, the use of the postcards and the invitation letter may be selected automatically by the campaign coach 110 based upon a calculated effectiveness of those types of marketing campaigns for a particular industry. This may be performed using weighting tables as disclosed by co-pending application Ser. No. 13/626,616, which is incorporated by reference in its entirety.

In one embodiment, the campaign coach 110 may have available one of a plurality of direct mail delivery methods to choose from. Each one of the direct mail delivery methods may have one or more parameters associated with them. For example, the one or more parameters may include a cost of the direct mail delivery method, an estimated delivery time of the direct mail delivery method or a type of direct mail marketing materials that can be used with the direct mail delivery method.

In one embodiment, the available delivery methods may include, for example from lowest cost to highest cost, United States Postal Service (USPS) Standard Mail®, USPS First Class Mail®, USPS Priority Mail®, Federal Express®, United Parcel Service®, and the like. The campaign coach 110 may know an estimated delivery time for each direct mail delivery method for each region that the direct mail delivery method may deliver to. For example, this information may be based on published information from the various delivery service providers.

However, based upon the marketing materials, the campaign coach 110 may eliminate some of the delivery methods. For example, USPS Priority Mail®, Federal Express® and United Parcel Service® may not be available for mailing postcards. As a result, the campaign coach 110 may choose between USPS Standard Mail® and USPS First Class Mail®. Thus, based on the current example, the campaign coach may determine that it is most cost effective to send the postcards and invitation letters using USPS Standard Mail®, while still reaching the destination of the postcards and invitation letters within a delivery due date.

Referring back to FIG. 2, the timeline 200 illustrates visually how the campaign coach 110 would recommend the direct mail marketing campaign given the one or more parameters associated with the event and the one or more parameters associated with each one of the direct mail delivery methods. In FIG. 2, line 202 illustrates time progressing from left to right. Line 204 illustrates that the current day is Jan. 1, 2012. The campaign coach 110 may recommend that an initial “save-the-date” postcard be mailed to members of the customer list for Labrador Retriever owners as soon as possible. Based upon the lead time to produce the “save-the-date” postcards, the campaign coach 110 may recommend mailing the “save-the-date” postcards in 2 weeks on Jan. 15, 2012 as illustrated by line 206 using USPS Standard Mail®.

The campaign coach 110 may determine based upon the lead time to produce personalized invitation letters, a historical time to respond to an invitation and delivery times (e.g., from Saint Louis, Mo. to the farthest destination) of the direct mail delivery method that is selected that the invitation letters should be mailed approximately 2 months before the date of the event on Feb. 1, 2012, as illustrated by line 208. The campaign coach 110 may determine that based upon the lead time to produce “reminder” postcards and delivery times (e.g., from Saint Louis, Mo. to the farthest destination) of the direct mail delivery method that the “reminder” postcards should be mailed 2 weeks before the event on Mar. 17, 2012 as illustrated by line 210. Line 212 illustrates the date of the event on Apr. 1, 2012.

It should be noted that the above timeline 200 is only one example. The timeline 200 may vary depending upon the one or more parameters associated with an event, the available direct mail delivery methods and the marketing campaigns that are recommended and/or selected.

As a result, the campaign coach 110 automatically recommends what types of marketing materials should be used, how the marketing materials should be delivered and when each one of the marketing materials should be mailed based upon information about the event and the available direct mail delivery methods. Thus, the campaign coach 110 alleviates the business owner of the small or medium sized business from having to make these decisions and calculations on his or her own.

In one embodiment, the campaign coach may recommend changing one or more parameters associated with the event to utilize a more cost effective direct mail delivery method. Some of the direct mail delivery methods may require a certain volume. For example, the USPS Standard Mail® may require a total of 200 pieces or 50 pounds of mail and require that each piece of mail be less than 16 ounces. Thus, if the business owner were only mailing out 195 postcards via USPS First Class Mail®, the campaign coach may recommend mailing an additional 5 postcards to utilize USPS Standard Mail® to save costs if the cost to print an additional 5 postcards is less than the cost savings achieved by using USPS Standard Mail® instead of USPS First Class Mail®. In another example, if the each piece of mail is 17 ounces, the campaign coach 110 may recommend reducing content or using lighter paper to reduce the weight to less than 16 ounces such that the USPS Standard Mail® may be used instead of USPS Priority Mail®.

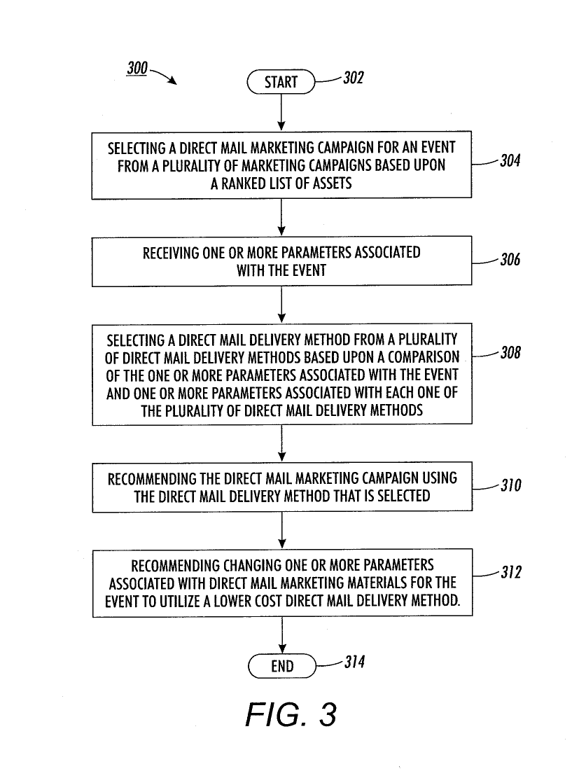

FIG. 3 illustrates a flowchart of a method 300 for recommending a direct mail marketing campaign for an event. In one embodiment, the method 300 may be performed by the automated marketing campaign coach 110 or a general-purpose computer as illustrated in FIG. 4 and discussed below.

The method 300 begins at step 302. At step 304, the method 300 selects the direct mail marketing campaign for the event from a plurality of marketing campaigns based upon a ranked list of assets. In one embodiment, a campaign coach may rank the assets of the business. In one embodiment, a ranked list of assets for the business may be generated by the campaign coach based upon a quality rating. The campaign coach may then select a marketing campaign tactic based upon the highest ranked asset in the ranked list of assets.

In one embodiment, the campaign coach may select the marketing campaign tactic automatically based upon a calculated effectiveness of those types of marketing campaigns for a particular industry. This may be performed using weighting tables as disclosed by co-pending application Ser. No. ______, which is incorporated by reference in its entirety. The plurality of marketing campaign tactics may include for example, mailing post cards, mailing flyers, mailing stationary, emailing customers, creating personalized universal resource locators (URLs), and the like.

At step 306, the method 300 receives one or more parameters associated with the event. For example, the one or more parameters associated with the event may include a date of the event, a location of the event and a type of marketing material to be used to promote the event.

At step 308, the method 300 selects a direct mail delivery method from a plurality of direct mail delivery methods based upon a comparison of the one or more parameters associated with the event and one or more parameters associated with each one of the plurality of direct mail delivery methods. In one embodiment, each one of the direct mail delivery methods may have one or more parameters associated with them. For example, the one or more parameters may include a cost of the direct mail delivery method, an estimated delivery time of the direct mail delivery method or a type of direct mail marketing materials that can be used with the direct mail delivery method.

In one embodiment, the available delivery methods may include, for example from lowest cost to highest cost, United States Postal Service (USPS) Standard Mail®, USPS First Class Mail®, USPS Priority Mail®, Federal Express®, United Parcel Service®, and the like. The campaign coach may know an estimated delivery time for each direct mail delivery method for each region that the direct mail delivery method may deliver to. For example, this information may be based on published information from the various delivery service providers.

However, based upon the marketing materials, the campaign coach may eliminate some of the delivery methods. For example, USPS Priority Mail®, Federal Express® and United Parcel Service® may not be available for mailing postcards. As a result, the campaign coach may choose between USPS Standard Mail® and USPS First Class Mail®. In one example, the campaign coach may determine it is most cost effective to send the postcards and invitation letters using USPS Standard Mail®, while still reaching the destination of the postcards and invitation letters within a delivery date goal. In other words, the campaign coach may compare how many days until the event date, a selected marketing material and a location of the event to the estimated days for delivery for the direct mail delivery methods from the location to the farthest destination and whether the direct mail delivery methods can be used for the selected marketing material.

At step 310, the method 300 recommends the direct mail marketing campaign using the direct mail delivery method that is selected. In one embodiment, the recommendation of the direct mail marketing campaign may include a time line of which marketing materials should be used, when the marketing materials should be sent and how the marketing materials should be delivered.

The method 300 may then perform optional step 312. At optional step 312, the method 300 recommends changing one or more parameters associated with direct mail marketing materials for the event to utilize a lower cost direct mail delivery method. For example, the campaign coach may recommend changing one or more parameters associated with the event to utilize a more cost effective direct mail delivery method. Some of the direct mail delivery methods may require a certain volume. For example, the USPS Standard Mail® may require a total of 200 pieces or 50 pounds of mail and require that each piece of mail be less than 16 ounces. Thus, if the business owner were only mailing out 195 postcards via USPS First Class Mail®, the campaign coach may recommend mailing an additional 5 postcards to utilize USPS Standard Mail® to save costs if the cost to print an additional 5 postcards is less than the cost savings achieved by using USPS Standard Mail® instead of USPS First Class Mail®. In another example, if the each piece of mail is 17 ounces, the campaign coach 110 may recommend using lighter paper to reduce the weight to less than 16 ounces such that the USPS Standard Mail® may be used instead of USPS Priority Mail®. The method ends at step 314.

It should be noted that although not explicitly specified, one or more steps, functions or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, blocks or operations in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises a hardware processor element 402 (e.g., a microprocessor, a central processing unit (CPU) and the like), a memory 404, e.g., random access memory (RAM) and/or read only memory (ROM), a module 405 for recommending a direct mail marketing campaign for an event, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed methods. In one embodiment, the present module or process 405 for recommending a direct mail marketing campaign for an event can be loaded into memory 404 and executed by processor 402 to implement the functions as discussed above. As such, the present method 405 for recommending a direct mail marketing campaign for an event (including associated data structures) of the present disclosure can be stored on a non-transitory (e.g., physical and tangible) computer readable storage medium, e.g., RAM memory, magnetic or optical drive or diskette and the like. For example, the hardware processor 402 can be programmed or configured with instructions (e.g., computer readable instructions) to perform the steps, functions, or operations of method 300.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for recommending a direct mail marketing campaign for an event, comprising:
selecting the direct mail marketing campaign for the event from a plurality of marketing campaigns based upon a ranked list of assets;
receiving one or more parameters associated with the event;
selecting, via a processor, a direct mail delivery method from a plurality of direct mail delivery methods based upon a comparison of the one or more parameters associated with the event and one or more parameters associated with each one of the plurality of direct mail delivery methods; and
recommending the direct mail marketing campaign using the direct mail delivery method that is selected.

2. The method of claim 1, wherein the ranked list of assets is ranked based upon a quality rating of each one of the list of assets.

3. The method of claim 2, wherein the quality rating is based upon at least one of: a freshness metric, a number of members in the asset, a completeness of the asset, a suitability of print of the asset, or an effectiveness of the asset.

4. The method of claim 3, wherein the effectiveness of the asset comprises a historical measure of a percentage of action taken by a particular group.

5. The method of claim 4, wherein the effectiveness of the asset comprises a recursive calculation.

6. The method of claim 1, wherein the one or more parameters associated with the event comprise at least one of: a type of the event, a date of the event, a type of direct mail marketing material, or a location of the event.

7. The method of claim 1, wherein the one or more parameters associated with each one of the plurality of direct mail delivery methods comprise at least one of: a cost of the direct mail delivery method, an estimated delivery time of the direct mail delivery method, or a type of direct mail marketing material that is used with the direct mail delivery method.

8. The method of claim 1, wherein the direct mail marketing campaign comprises a time line of when one or more direct mail marketing materials should be sent using the direct mail delivery method that is selected based upon the one or more parameters associated with the event.

9. The method of claim 1, further comprising:
recommending a change of one or more parameters associated with direct mail marketing materials for the event to utilize a lower cost direct mail delivery method.

10. A non-transitory computer-readable medium having stored thereon a plurality of instructions, the plurality of instructions including instructions which, when executed by a processor, cause the processor to perform operations for recommending a direct mail marketing campaign for an event, the operations comprising:
selecting the direct mail marketing campaign for the event from a plurality of marketing campaigns based upon a ranked list of assets;
receiving one or more parameters associated with the event;
selecting a direct mail delivery method from a plurality of direct mail delivery methods based upon a comparison of the one or more parameters associated with the event and one or more parameters associated with each one of the plurality of direct mail delivery methods; and
recommending the direct mail marketing campaign using the direct mail delivery method that is selected.

11. The non-transitory computer-readable medium of claim 10, wherein the ranked list of assets is ranked based upon a quality rating of each one of the list of assets.

12. The non-transitory computer-readable medium of claim 11, wherein the quality rating is based upon at least one of: a freshness metric, a number of members in the asset, a completeness of the asset, a suitability of print of the asset or an effectiveness of the asset.

13. The non-transitory computer-readable medium of claim 12, wherein the effectiveness of the asset comprises a historical measure of a percentage of action taken by a particular group.

14. The non-transitory computer-readable medium of claim 13, wherein the effectiveness of the asset comprises a recursive calculation.

15. The non-transitory computer-readable medium of claim 10, wherein the one or more parameters associated with the event comprise at least one of: a type of event, a date of the event, a type of direct mail marketing material, or a location of the event.

16. The non-transitory computer-readable medium of claim 10, wherein the one or more parameters associated with each one of the plurality of direct mail delivery methods comprise at least one of: a cost of the direct mail delivery method, an estimated delivery time of the direct mail delivery method or a type of direct mail marketing material that is used with the direct mail delivery method.

17. The non-transitory computer-readable medium of claim 10, wherein the direct mail marketing campaign comprises a time line of when one or more direct mail marketing materials should be sent using the direct mail delivery method that is selected based upon the one or more parameters associated with the event.

18. The non-transitory computer-readable medium of claim 10, further comprising:
recommending a change of one or more parameters associated with direct mail marketing materials for the event to utilize a lower cost direct mail delivery method.

19. A method for recommending a direct mail marketing campaign for an event, comprising:
selecting the direct mail marketing campaign for the event from a plurality of marketing campaigns based upon a ranked list of assets, wherein a customer list asset of the ranked list of assets is determined to have a highest quality rating based upon a freshness metric, a number of members in the asset, a completeness of the asset and an effectiveness of the asset;
receiving a plurality of parameters associated with the event, wherein the plurality of parameters comprises a type of event, a date of the event, a type of direct mail marketing material and the location of the event;
selecting a direct mail delivery method from a plurality of direct mail delivery methods based upon a comparison of the plurality of parameters associated with the event and a plurality of parameters associated with each one of the plurality of direct mail delivery methods, wherein the plurality of parameters associated with each one of the plurality of direct mail delivery methods comprises a cost of the direct mail delivery method, an estimated delivery time of the direct mail delivery method and a type of direct mail marketing material that is used with the direct mail delivery method; and
recommending the direct mail marketing campaign using the direct mail delivery method that is selected, wherein the direct mail marketing campaign comprises a timeline of when the type of direct mail marketing material should be sent using the direct mail delivery method that is selected.

20. The method of claim 19, further comprising:
recommending a change of one or more parameters associated with direct mail marketing materials for the event to utilize a lower cost direct mail delivery method.
